(19) United States
(12) Patent Application Publication
(10) Pub. No.: US 2015/0206405 A1
(43) Pub. Date: Jul. 23, 2015

(54) PLANTER ACCESSORY FOR CONCEALING A CAMERA

(71) Applicant: SAMMIE J. SANFORD, JR., Fairburn, GA (US)

(72) Inventor: SAMMIE J. SANFORD, JR., Fairburn, GA (US)

(21) Appl. No.: 14/602,387

(22) Filed: Jan. 22, 2015

Related U.S. Application Data
(60) Provisional application No. 61/930,093, filed on Jan. 22, 2014.

(51) Int. Cl. G08B 15/00; H04N 7/18; G08B 13/196

(52) U.S. Cl. CPC G08B 15/001; G08B 13/19619; H04N 7/18

(57) ABSTRACT

A planter accessory for concealing a camera or detector includes a flexible, conformable ring having a curved cross-sectional shape. The ring is fittable on an upper edge of a planter. A detecting device is mounted in a concealed disposition on the ring providing capture of images or movements around the planter on which the ring is positioned.

### CROSS REFERENCE TO RELATED APPLICATION

This application claims the priority of U.S. Provisional Application No. 61/930,093 filed Jan. 22, 2014.

### TECHNICAL FIELD

This invention relates to planters and in particular to an accessory that is fittable onto an existing planter.

### BACKGROUND OF THE INVENTION

It is known in the art relating to residential and commercial security to provide cameras or other detecting devices for surveillance of a premise and detection of an intruder or other suspicious activity. Such cameras and other detecting devices are typically mounted on a ceiling or an indoor or outdoor wall. Some ceiling cameras may also be covered by plastic or glass globe (which may be tinted) in an attempt to hide the camera from view. However, criminals are aware of these security cameras and may attempt to avoid them. Therefore, a need exists for security and surveillance cameras that are hidden from view and that are undetectable by intruders and criminals.

### SUMMARY OF THE INVENTION

The present invention provides a planter accessory for concealing a camera or other detecting device that is fittable onto an existing planter to allow mounting or placement of the concealed camera or detecting device on the planter. The planter accessory allows for remote monitoring of an area in proximity to a planter on which the planter accessory is mounted. The planter accessory may be an element of on-premise security system, or may be a standalone tool for improving the security of a home or business.

More particularly, a planter accessory in accordance with the invention includes a flexible, conformable ring having a curved cross-sectional shape and being fittable on an upper edge of a planter. A detecting device is mounted in a concealed disposition on the ring providing capture of images or movements around the planter on which the ring is positioned.

The detecting device may be a video camera, an infrared camera, a motion detector, or similar. The accessory may include a plurality of the detecting devices, and the detecting devices may be spacedly disposed at intervals around the ring. The detecting device may be mounted in a side wall of the ring. The accessory may include one or more decorative lights disposed adjacent to apertures in the ring.

These and other features and advantages of the invention will be more fully understood from the following detailed description of the invention taken together with the accompanying drawings.

### BRIEF DESCRIPTION OF THE DRAWINGS

In the drawings:

FIG. 1 is a perspective view of a planter including a planter accessory in accordance with the invention;

FIG. 2 is a side view of the planter including the planter accessory of FIG. 1;

FIG. 3 is a top view of the planter including the planter accessory of FIG. 1; and

FIG. 4 is a sectional view of the planter including the planter accessory of FIG. 1.

### DETAILED DESCRIPTION OF THE INVENTION

Referring now to the drawings in derail, numeral 10 generally indicates a planter accessory in accordance with the invention. The planter accessory provides a decorative rim along an upper edge of a planter while also providing for concealed monitoring of the space around the planter accessory.

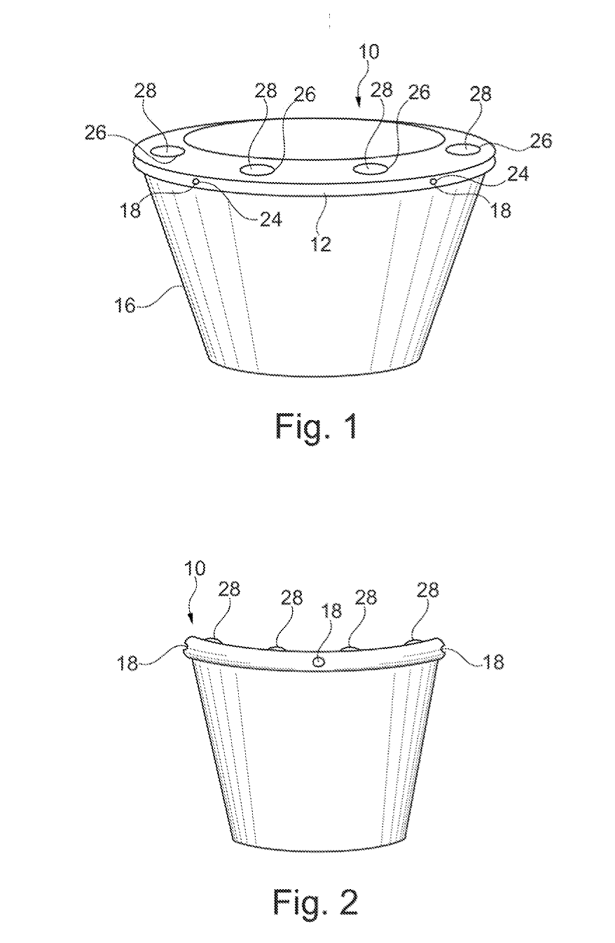

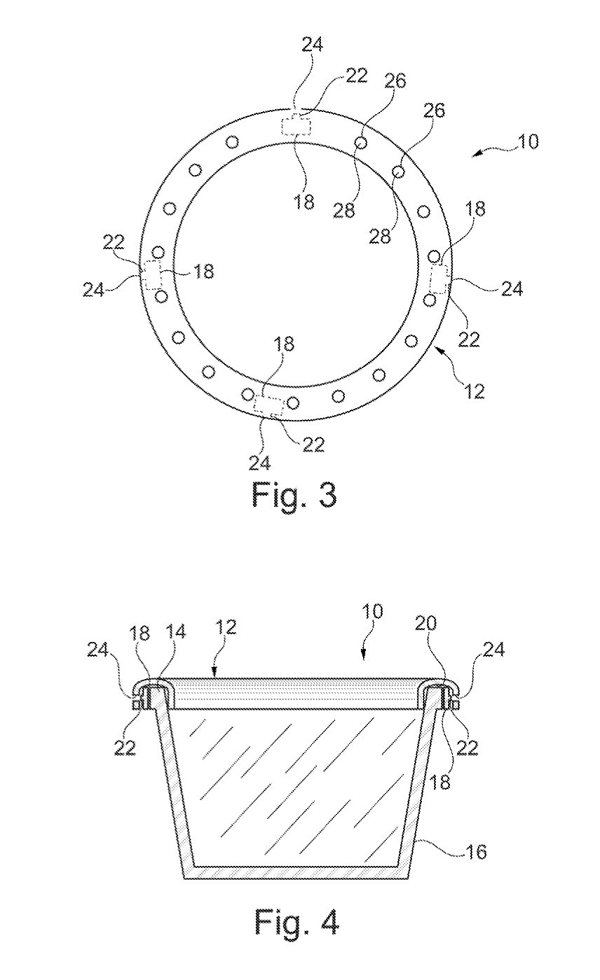

As shown in FIGS. 1 through 4, the planter accessory 10 includes a flexible, conformable ring 12 generally having a curved cross-sectional shape. The ring 12 is made of a shapeable material such as a plastics material, a rubber-like material, or similar, and may be formed by molding or similar. More specifically, the ring 12 may include an inverted u-shape cross-sectional portion that allows the annular ring to be fitted on an upper edge 14 of a planter 16. The planter 16 may be a flower pot, a tree pot, or other similar open-top container for holding and growing plants such as flowers, vegetables, small bushes or trees, and the like. The ring 12 may be annular in shape, or may otherwise be conformable to the shape of the upper edge 14 of the planter 16. For example, if the planter has a curved upper edge, the ring may have a cooperatively curved shape, or if the planter has a straight upper edge, the ring may generally conform to the straight shape of the upper edge.

A detecting device 18 is mounted in a concealed disposition on the ring 12 providing capture of images or movements around the planter 16 on which the ring is positioned. The detecting device 18 may be a video camera or similar device such as a motion detector, an infrared (thermographic) camera, or similar. As shown in FIG. 4, in the concealed disposition the detecting device 18 may be nearly completely disposed on the inside of the ring 12 and mounted on an inner surface 20 of the ring, thereby shielding the camera from view on the outside of the ring. Only the outer part of the lens portion 22 may be left uncovered. Specifically, the lens portion 22 may be aligned with an aperture 24 so that the detecting device 18 can sense objects and/or movements around the planter 16 on which the ring is positioned.

More than one detecting device 18 can be concealed around the accessory 10 to sense different fields of view. For example, the detecting devices 18 may be spacedly disposed in separate locations at intervals around the sidewall of the annular ring.

The ring 12 may include a plurality of apertures 26, and a light source 28 such as an incandescent light source, an LED light source, a fiber optic light assembly, or similar may be mounted in each aperture. Alternatively, the light source may be mounted on the inside of the annular ring to provide one or both of upward illumination, through the apertures, of a space above the planter (such as a space partially or wholly occupied by a plant disposed in the planter) and downward illumination of the planter including the outer wall(s) of the planter. The light source 28 may be a single bulb or may include a plurality of individual lights that are electrically connected. Alternatively, the light source 28 may include a translucent, hollow rope or ring containing one or more lights therein. The light source 28 may provide decorative lighting of the accessory 10, and may also aid in illuminating the space around the planter 16 to improve the view provided by the detecting device 18, especially in dark or low-light ambient conditions.

The detecting device 18 and the light source 28 may be powered by a battery, household electricity, solar power, or similar. Electrical power may be provided to the detecting device and light source through wiring as is conventional, and the wiring may be at least partially hidden underneath the ring 12. The ring alternatively may include a battery mount for mounting batteries on the ring, and may include a switch for controlling the detecting and illumination provided by the detecting device and light source, respectively.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A planter accessory for concealing a camera or detector, the planter accessory comprising:
a flexible, conformable ring having a curved cross-sectional shape and being fittable on an upper edge of a planter; and
a detecting device mounted in a concealed disposition on said ring providing capture of images or movements around the planter on which said ring is positioned.

2. The planter accessory of claim 1, wherein the detecting device is a video camera.

3. The planter accessory of claim 1, wherein the detecting device is an infrared camera.

4. The planter accessory of claim 1, wherein the detecting device is a motion detector.

5. The planter accessory of claim 1, including a plurality of said detecting devices.

6. The planter accessory of claim 5, wherein said detecting devices are spacedly disposed at intervals around said ring.

7. The planter accessory of claim 1, wherein said detecting device is mounted in a sidewall of said ring.

8. The planter accessory of claim 1, including one or more decorative lights disposed adjacent to apertures in said ring.
